(19) United States
(12) Patent Application Publication
(10) Pub. No.: US 2014/0352359 A1
(43) Pub. Date: Dec. 4, 2014

(54) COMPOSITE GLASS FORMING SYSTEM

(71) Applicant: Fortune Technology Corp., Taipei City (TW)

(72) Inventor: Allen Yu, Taipei (TW)

(73) Assignee: Fortune Technology Corp., Taipei City (TW)

(21) Appl. No.: 14/034,773

(22) Filed: Sep. 24, 2013

(30) Foreign Application Priority Data
May 31, 2013 (TW) 102119315

(51) Int. Cl. C03B 17/06

(52) U.S. Cl. CPC C03B 17/064
USPC 65/184

(57) ABSTRACT

A composite glass forming system applied in the process of producing sheet glass mainly comprises a slotted nozzle downdraw glass forming device and an overflow downdraw glass forming device. The slotted nozzle downdraw glass forming device possesses a nozzle and the overflow downdraw glass forming device is located below the said nozzle. When glass liquid is injected into the slotted nozzle downdraw glass forming device, the glass liquid will flow down through the nozzle to a flow guiding surface formed on the overflow downdraw glass forming device. Then, the overflow downdraw glass forming device makes glass liquid in shape of thin smooth surface sheet glass by using overflow downdraw method.

### BACKGROUND OF THE INVENTION

1. Technology Field

This invention, related to a composite glass forming system applied in the process of producing sheet glass, simultaneously adopts “slotted nozzle downdraw” and “overflow downdraw” methods to approach forming sheet glass.

2. Prior Arts

Conventional sheet glass forming method mainly comprises slotted nozzle downdraw method, overflow downdraw method, and float glass method. Among which, the slotted nozzle downdraw method and the overflow downdraw method both are in the concept of gravitation to have the fusion of glass i.e. glass liquid (also called glass paste) flowing downward through cooling process to solidify the glass liquid into a sheet glass (flat glass) output.

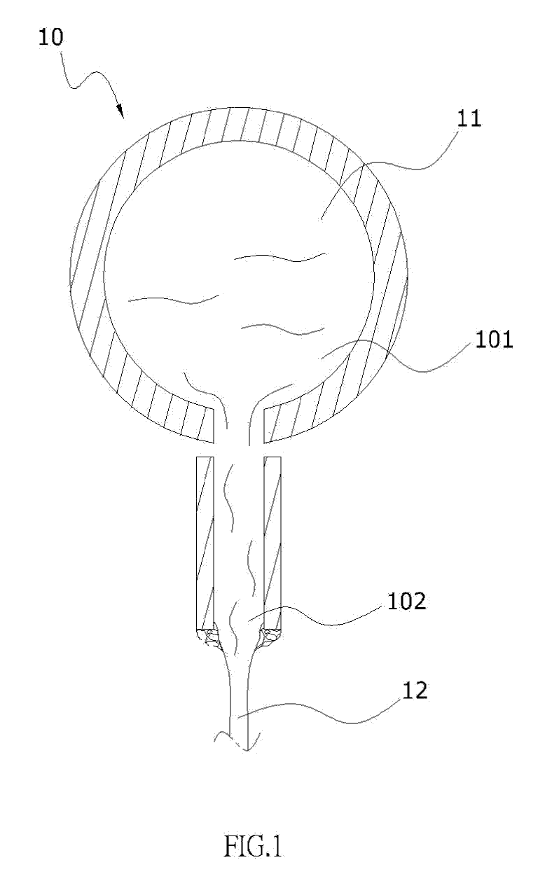

Referring to FIG. 1, this is a glass forming distributor 10 with a distributor 101 and a nozzle 102 located below the distributor 101. When the glass liquid 11 is injected into the distributor 101, the glass liquid 11 under the gravitation effect flows out of the nozzle 102 and forms a sheet glass 12. The glass forming distributor 10 is mainly to form sheet glass by slotted nozzle downdraw method, its advantage is to control the thickness of the sheet glass 12 by the glass forming distributor 10 and the nozzle 102. Not like overflow downdraw to re-adhesive two distributed sheets into one, this method can get thinner sheet glass. However, the disadvantage is, when glass liquid flowing out in shape of sheet glass, the sheet glass surface will have scratch defects due to contact the forming outlet (nozzle 102 in this figure). Hence, the finished products need secondary polish process to accomplish sheet glass with smooth surface.

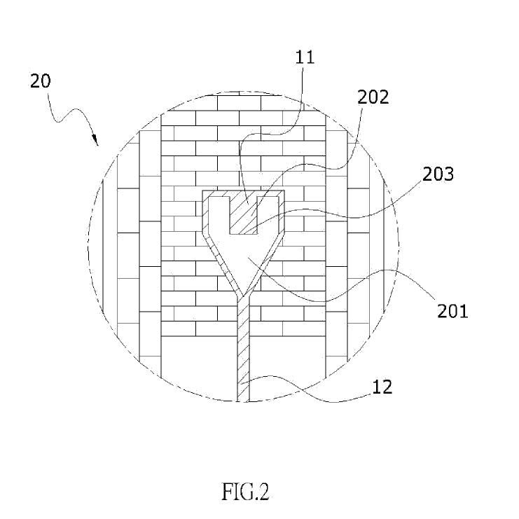

Referring to FIG. 2, this is a glass forming device 20 mainly with a body 201 which is covering an overflow trough 202 and a flow channel 203 on the bottom of body 201. When glass liquid 11 is filling up the flow channel 203, going further overflow from both sides of body 201 and then adhesive a flat glass 12 just right under the body 201. The advantage of this glass forming device 20 is able to get sheet glass 12 smoothly, but its disadvantage is way too expensive on building cost. Meanwhile, in order to keep the temperature of the glass liquid 11 inside the overflow trough 202, the glass forming device 20 normally has to be placed within a Muffle 21, which is able to maintain required temperature. Therefore, the overall manufacturing cost of the sheet glass 12 will be further pushed up.

As stated, above two types of glass forming device (10, 20) are the most popular equipments used by the industries in this field to produce sheet glass 12, each glass forming device (10, 20) has its own advantages and disadvantages. If the positive and negative of two glass forming device (10, 20) can be integrated effectively, the sheet glass definitely can be costed down and the overall yield rate of the sheet glass can be simultaneously upgraded.

### SUMMARY OF THE INVENTION

In view of the above demand, the main goal of this invention is to provide a composite glass forming device with the effective function of lowering down the manufacturing cost and increase in the overall yield rate of the sheet glass.

This invention, the composite glass forming system is to achieve above goal, consisting of a slotted nozzle downdraw glass forming device and an overflow downdraw glass forming device. The slotted nozzle downdraw glass forming device is the slotted nozzle downdraw type with a nozzle, and the overflow downdraw glass forming device is an improved overflow glass forming device which is located below the nozzle of the slotted nozzle downdraw glass forming device. When glass liquid is injected into the slotted nozzle downdraw glass forming device, the glass liquid will flow down through the nozzle to the flow guiding surface formed on the overflow downdraw glass forming device. Then, the overflow downdraw glass forming device makes glass liquid in shape of the thin smooth surface sheet glass by means of overflow downdraw principle

### BRIEF DESCRIPTION VIA ILLUSTRATION

For well understanding the specified structure, composition and function of this invention, hereunder is the corresponding illustration:

FIG. 1 is a conventional slotted nozzle downdraw type glass forming device.

FIG. 2 is another conventional overflow downdraw type glass forming device.

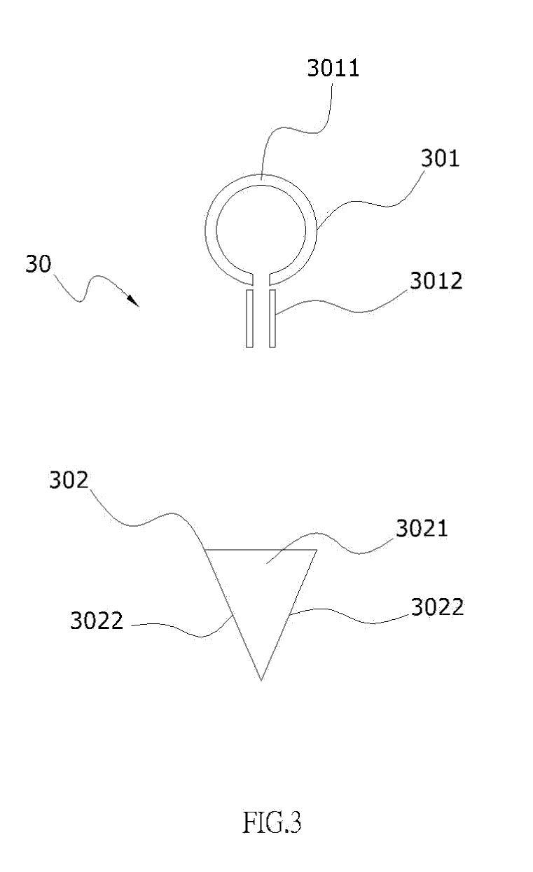

FIG. 3 shows the component of this invention.

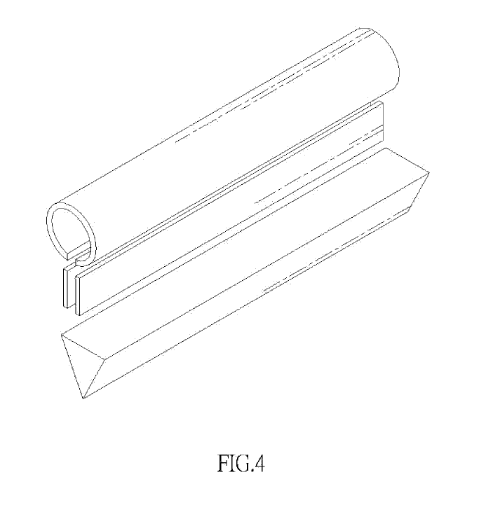

FIG. 4 shows the three-D profile of this invention.

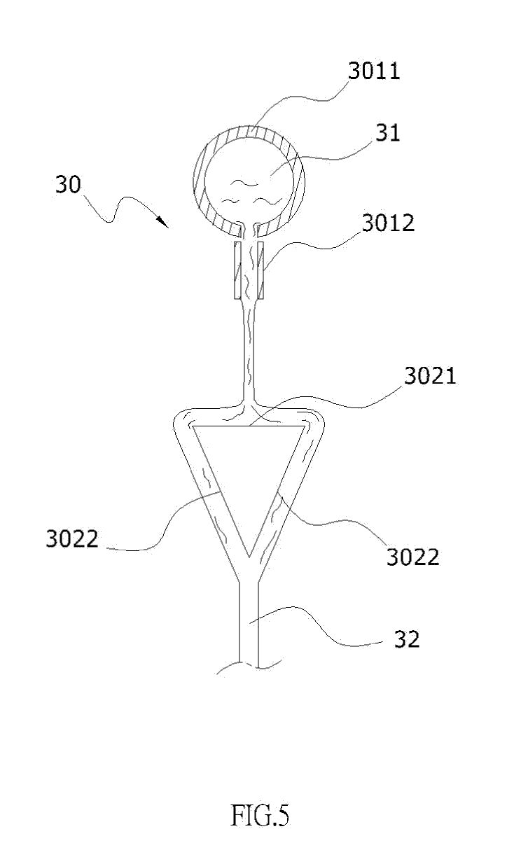

FIG. 5 shows the flowchart of this invention.

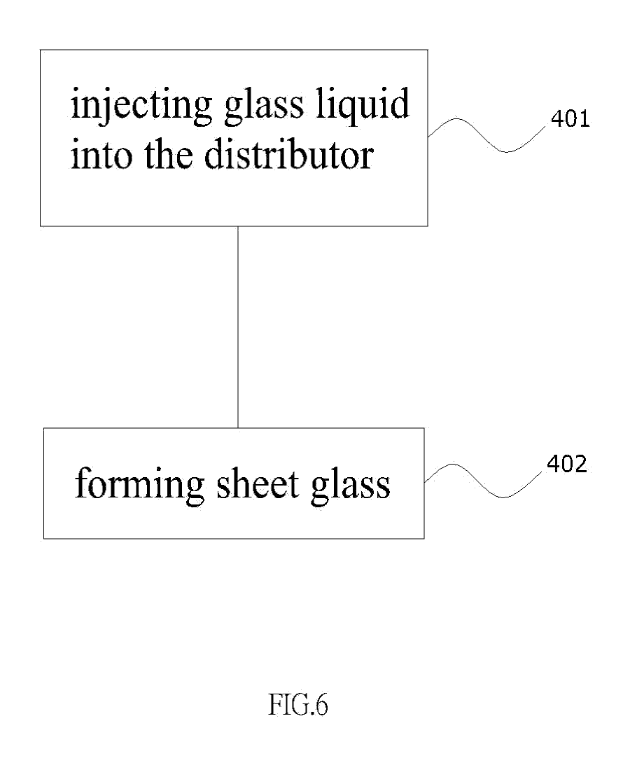

FIG. 6 shows the described process of this invention.

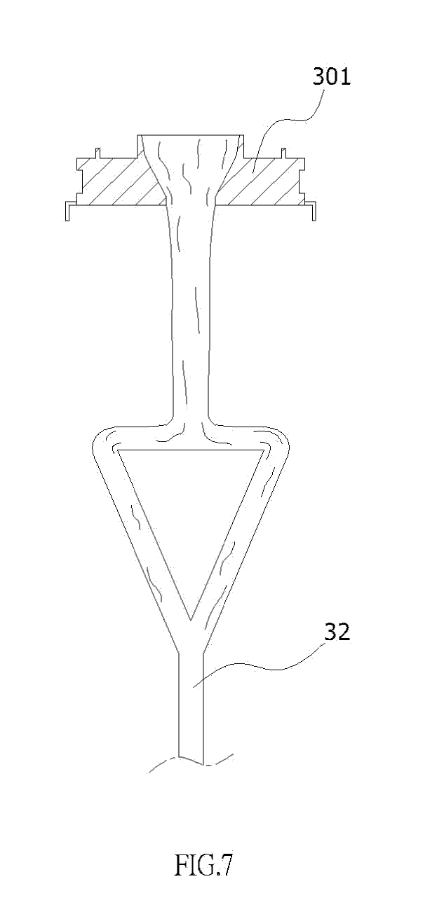

FIG. 7 shows another execution case (I) of this invention.

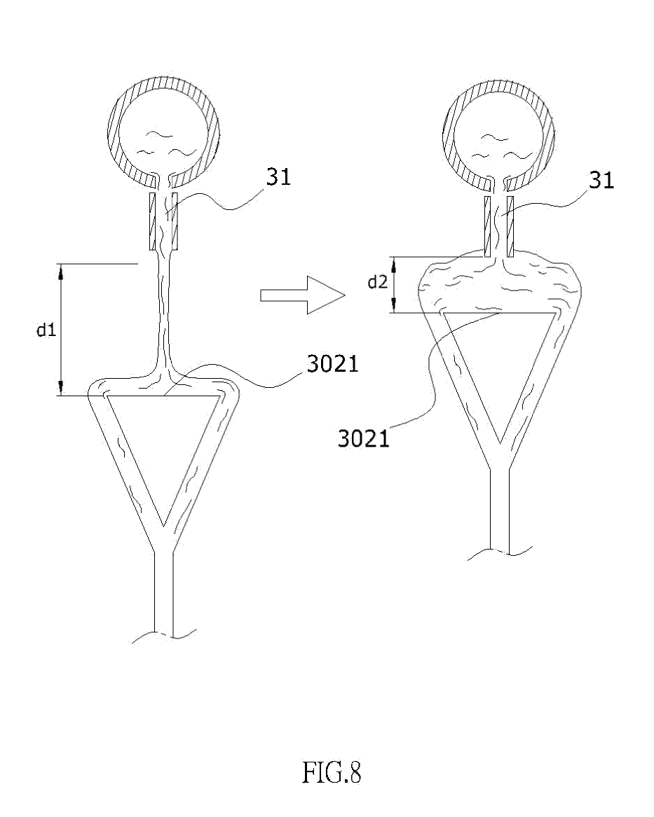

FIG. 8 shows another execution case (II) of this invention.

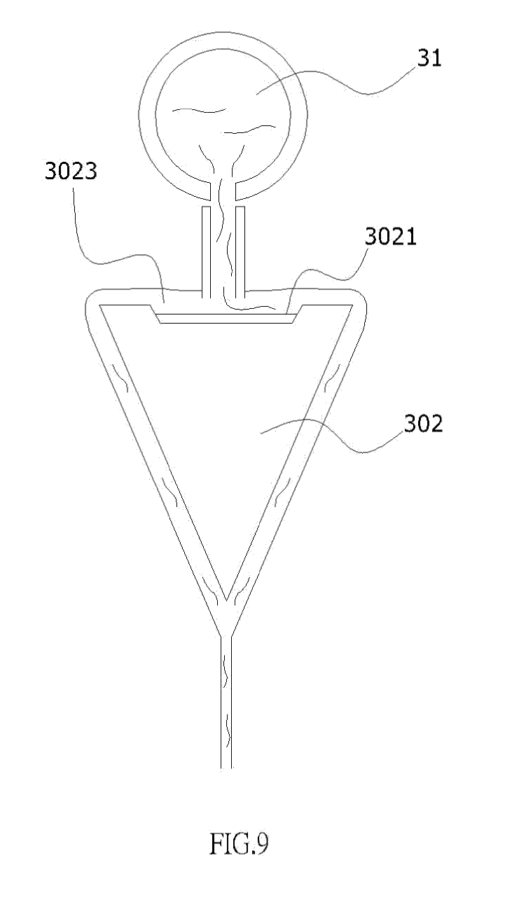

FIG. 9 shows another execution case (III) of this invention.

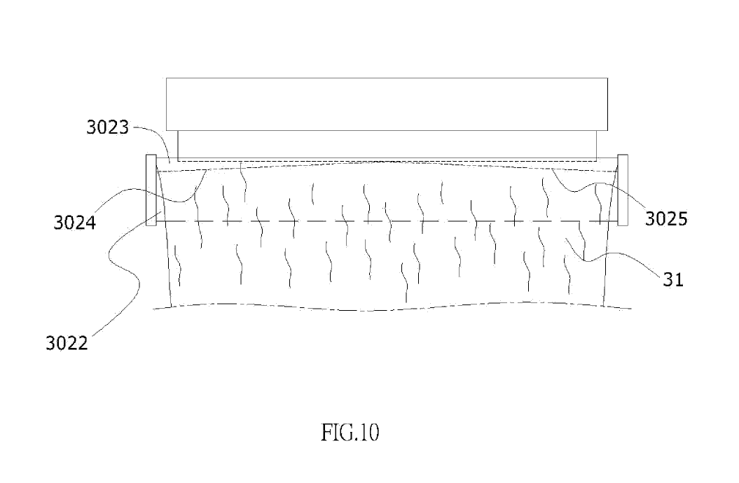

FIG. 10 shows profile view of execution case (III).

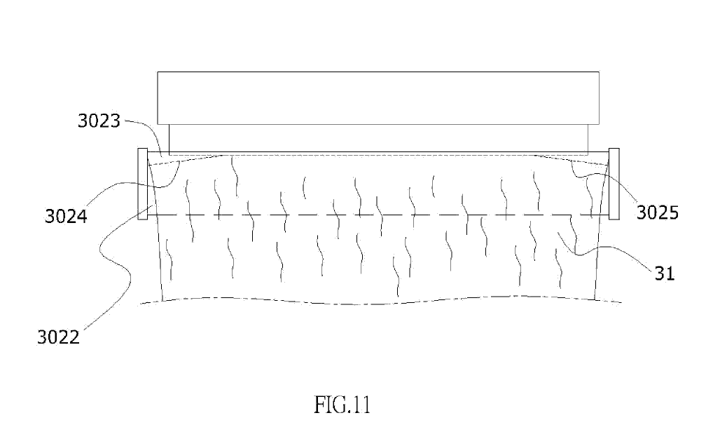

FIG. 11 shows another execution case (IV) of this invention.

### DETAILED DESCRIPTION OF EXECUTION

Referring to FIG. 3, here is showing all components of this invention, a composite glass forming system 30 comprising a slotted nozzle downdraw glass forming device 301 and an overflow downdraw glass forming device 302. The slotted nozzle downdraw glass forming device 301 possess a distributor 3011 and a nozzle 3012 which is connected to the distributor 3011 from below. The nozzle 3012 will lead the fusion glass liquid to flow down through the nozzle 3012 along the longitudinal direction of the distributor 3011. The overflow downdraw glass forming device 302 is located below the slotted nozzle downdraw glass forming device 301. The overflow downdraw glass forming device 302 has a flow guiding surface 3021 facing the nozzle 3012, and the flow guiding surface 3021 extended downward from both sides as an overflow surface 3022, which is slanted against the horizontal flow guiding surface 3021, so the overall overflow downdraw glass forming device 302 is presented as a reversed triangle. FIG. 4 shows the three-D profile of this device, which is much smaller and geometric simple compared to a traditional overflow trough and much cheaper.

Referring to FIG. 5, here is the flowchart of this invention the composite glass forming system 30, the glass liquid 31 in molten state will be guided into the distributor 3011 of the slotted nozzle downdraw glass forming device 301 in advance, and the glass liquid 31 inside the distributor 3011 will flow downward through the nozzle 3012 to the flow guiding surface 3021 of the overflow downdraw glass forming device 302, gradually accumulate on the flow guiding surface 3021 and further spreads out toward both sides of the flow guiding surface 3021 then flows downward along the overflow surfaces 3022 on both sides of the flow guiding surface 3021, and in the end gathers on the bottom of the overflow downdraw glass forming device 302 in shape of an even thickness and smooth flat glass. Comparing to the conventional technology, this invention mainly has the glass liquid led into the slotted nozzle downdraw glass forming device 301 in advance, using this device to get sheet glass with even thickness. Furthermore, the glass liquid 31 flowing from the slotted nozzle downdraw glass forming device 301 and then through the overflow downdraw glass forming device 302 as per overflow downdraw principle is in shape of sheet glass 32, whereby the disadvantage of slotted nozzle downdraw glass forming device (i.e., scratch occurred due to glass surface contacted with the nozzle 3012) can be removed, and simultaneously the advantage of overflow downdraw glass forming device (i.e., finished products in smooth surface) can be obtained. Since the thickness of glass is even, no need to set up complicated overflow brick (special calculation of flow channel curve and overflow angle) to solve the thickness issue, the huge expense of brick and complicated expensive processing can be saved. Hence, the execution of this invention is able to effectively lower manufacturing cost and increase yield rate of the sheet glass 32.

Referring to FIG. 6, it is the described process of this invention to be referring to FIGS. 3 to 5 as well, the manufacturing flowchart of sheet glass under this invention will be as below.
(1) 401 injecting glass liquid into the distributor: through the distributor 3011 and the nozzle 3012, the amount of glass liquid flowing out from the slotted nozzle downdraw glass forming device 301 can be effectively regulated, and the thickness uniformity can be controlled as well.
(2) 402 forming sheet glass: as stated above, the glass liquid 31 flowing out of the nozzle 3012 further to the flow guiding surface 3021 of the overflow downdraw glass forming device 302. When the flow guiding surface 3021 is fully spread by glass liquid 31, the glass liquid 31 flows along the overflow surface 3022 on both sides down to the bottom of the overflow downdraw glass forming device 302, get together to form sheet glass 32 with smooth surfaces.

Referring to FIG. 7, it is another execution case (I) of this invention, the slotted nozzle downdraw glass forming device 301 on this invention can also be a downdraw glass forming device as shown in figures. It is well known from the above that this invention mainly adopts the slotted nozzle downdraw glass forming device with the nature of slotted nozzle downdraw glass forming to manufacture the sheet glass 32. Apparently, the slotted nozzle downdraw glass forming device 301 shown on this invention is just an example, not subject to the category of the slotted nozzle downdraw glass forming device 301. Any glass forming device with nature of slotted nozzle downdraw can be used as the slotted nozzle downdraw glass forming device 301 of this invention.

Referring to FIG. 8, it is another execution case (II) of this invention, when the glass liquid 31 flows out of the nozzle 3012, to avoid the glass liquid during the process of forming from being affected by environment nearby such as temperature variation or uncontrolled airflow, certain distance d1 between the nozzle 3012 and the flow guiding surface 3021 can be shortened further to distance d2, whereby, to reduce the influence of environment to the glass liquid 31.

Referring to FIG. 9, it is another execution case (III) of this invention, to increase the fluidity of the glass liquid 31 close to the bottom of the flow guiding surface 3021, a fillister 3023 may be designed on the flow guiding surface 3021 of the overflow downdraw glass forming device 302. FIG. 10 is a profile view of the execution case (III) of this invention. As shown on FIG. 10, a first slanted surface 3024 and a second slanted surface 3025 are respectively formed on both sides of the fillister 3023. When the glass liquid 31 flows to the flow guiding surface 3021, the glass liquid 31 can flow smoothly toward the slanted surfaces (3024, 3025) on both sides of the fillister 3023 under the gravitational effect due to inclined angles shaped on both slanted surfaces (3024, 3025), so that the glass liquid 31 is facilitated to spill from the overflow surface 3022 smoothly. Moreover, the configuration of the first slanted surface 3024 and the second slanted surface 3025 can be shaped as that shown on FIG. 11.

According to foregoing description, this invention the composite glass forming system is mainly to control the glass liquid flow rate via the first slotted nozzle downdraw glass forming device so that the flowing glass liquid can pre-shape with appropriate thickness; and then cooperating with the second improved overflow downdraw glass forming device to accomplish the manufacturing of sheet glass. Whereby, the disadvantage of slotted nozzle downdraw glass forming device (i.e., frozen glass might be formed at the outlet of the nozzle 3012) can be eliminated, and simultaneously the advantage of overflow downdraw glass forming device (i.e., finished products with smooth surface so as to produce thin and smooth surface sheet glass) can be obtained. Therefore, the manufacturing cost of the sheet glass can be effectively lowered down and yield rate can be increased through the execution of this invention.

While the above description is just the examples of this invention, not subject to its scope; any familiarity with this art, as long as the variation and modification not apart from the spirit and scope of this invention, all should be identified as the scope of this invention inclusively.

1. A composite glass forming system applied in the process of producing sheet glass, in which glass liquid in molten state is led into, comprising:
a slotted nozzle downdraw glass forming device possessing a distributor for injecting the said glass liquid, and a nozzle located below the said distributor;
an overflow downdraw glass forming device located below the said nozzle, possessing a flow guiding surface, along two ends of the guiding surface extending downward as two overflow surfaces respectively, said two overflow surfaces will connect altogether at the end of their bottom; and
said nozzle of said slotted nozzle downdraw glass forming device and said flow guiding surface of said overflow downdraw glass forming device will be up and down opposite to each other.

2. The composite glass forming system as claimed in claim 1, wherein a fillister is formed on said flow guiding surface of said overflow downdraw glass forming device, and a first slanted surface and a second slanted surface are respectively formed on both sides of the fillister.
